(19) United States
(12) Patent Application Publication
(10) Pub. No.: US 2009/0256886 A1
(43) Pub. Date: Oct. 15, 2009

(54) Liquid-Droplet Ejection Head and Ink Jet Printer

(75) Inventor: Taiki Irie, Nagoya-shi (JP)

Correspondence Address: BANNER & WITCOFF, LTD.;ATTORNEYS FOR CLIENT NO. 016689, 1100 13th STREET, N.W., SUITE 1200, WASHINGTON, DC, 20005-4051, US

(73) Assignee: Brother Kogyo Kabushiki Kaisha, Nagoya-shi (JP)

(21) Appl. No.: 12/412,460

(22) Filed: Mar. 27, 2009

(30) Foreign Application Priority Data
Mar. 27, 2008 (JP) 2008-084269

(51) Int. Cl. B41J 2/135

(52) U.S. Cl. 347/44

(57) ABSTRACT

A liquid-droplet ejection head may include stacked plates that form therein a common liquid channel and a plurality of individual ink channels extending from exits from the common liquid channel to nozzles via pressure chambers. At least one of the stacked plates may include an island-shaped partial plate surrounded by the common liquid channel and configured to form at least a part of side walls of the common liquid channel. The stacked plates may also include a support portion that transverse the common liquid channel and configured to support the partial plate. At least a part of a side edge of the support portion on an upstream side of a flow direction of liquid in the common liquid channel may be inclined to the flow direction, as viewed in a direction perpendicular to the stacked plates.

### CROSS REFERENCE TO RELATED APPLICATION

This application claims priority to Japanese Patent Application No. 2008-084269, filed Mar. 27, 2008, the entire subject matter and disclosure of which is incorporated herein by reference.

### BACKGROUND OF THE INVENTION

1. Field of the Invention

The invention relates to a liquid-droplet ejection head for ejecting liquid droplets onto the recording medium and an ink jet printer including the liquid-droplet ejection head.

2. Description of the Related Art

A known ink jet head for ejecting ink droplets includes a channel unit in which a common ink chamber and a plurality of individual ink channels are formed. The common ink chamber includes a plurality of manifold channels. The individual ink channels extend from exits from the manifold channels through pressure chambers to nozzles. The channel unit has a laminated structure in which a plurality of plates are stacked. Among these plates, manifold plates defining the side walls of the manifold channels include island-shaped partial plates surrounded by the manifold channels. The partial plates transverse the manifold channels and are supported by rectangular support portions connected to the opposite side walls of the manifold channels.

In the above-described ink jet head, bubbles flowing into the manifold channels stick to the side edges of the support portions and tend to stay in the manifold channels. Because the side edges of the support portions are perpendicular to a direction in which the manifold channels extend, i.e., a direction in which ink flows. As a result, a large amount of ink has to be discharged to discharge the bubbles outside, resulting in unnecessary consumption of ink.

### SUMMARY OF THE INVENTION

A need has arisen for a liquid-droplet ejection head and an ink jet printer allowing efficiently discharging bubbles flowing into a common liquid channel.

According to one embodiment herein, a liquid-droplet ejection head may include stacked plates that form therein a common liquid channel and a plurality of individual ink channels extending from exits from the common liquid channel to nozzles via pressure chambers. At least one of the stacked plates may include an island-shaped partial plate surrounded by the common liquid channel and configured to form at least a part of side walls of the common liquid channel. The stacked plates may also include a support portion that transverse the common liquid channel and configured to support the partial plate. At least a part of a side edge of the support portion on an upstream side of a flow direction of liquid in the common liquid channel may be inclined to the flow direction, as viewed in a direction perpendicular to the stacked plates.

According to another embodiment herein, an ink jet printer may include a liquid-droplet ejection head including stacked plates that form therein a common liquid channel and a plurality of individual ink channels extending from exits from the common liquid channel to nozzles via pressure chambers. The ink jet printer may also include a sheet feeding device configured to feed a recording medium. The ink jet printer may further include a sheet discharge device configured to discharge the recording medium. The ink jet printer may yet further include a sheet conveying path extending from the sheet feeding device to the sheet discharge device along which the recording medium is conveyed. At least one of the stacked plates may include an island-shaped partial plate surrounded by the common liquid channel and configured to form at least a part of side walls of the common liquid channel. The stacked plates may also include a support portion that transverse the common liquid channel and configured to support the partial plate. At least a part of a side edge of the support portion on an upstream side of a flow direction of liquid in the common liquid channel may be inclined to the flow direction, as viewed in a direction perpendicular to the stacked plates.

Other objects, features and advantages will be apparent to those skilled in the art from the following detailed description and accompanying drawings.

### BRIEF DESCRIPTION OF THE DRAWINGS

FIG. 1 is an external side view of an ink jet printer including an ink jet head according to an embodiment.

FIG. 2 is a plan view of a head body.

FIG. 3 is an enlarged view of a region enclosed by an alternate long and short dash line shown in FIG. 2.

FIG. 4 is a sectional view taken along line IV-IV in FIG. 3.

FIG. 5 is a plan view of a plurality of manifold plates constituting side walls of manifold channels.

FIG. 6 is a plan view of the manifold channels.

FIG. 7 is a sectional view taken along line VII-VII in FIG. 6.

FIG. 8 is a bottom view of a sub-manifold channel.

FIGS. 9A to 9C show modification examples.

### DESCRIPTION OF THE EMBODIMENTS

Embodiments are described with reference to the accompanying drawings, which are given by way of example only, and are not intended to limit the present invention.

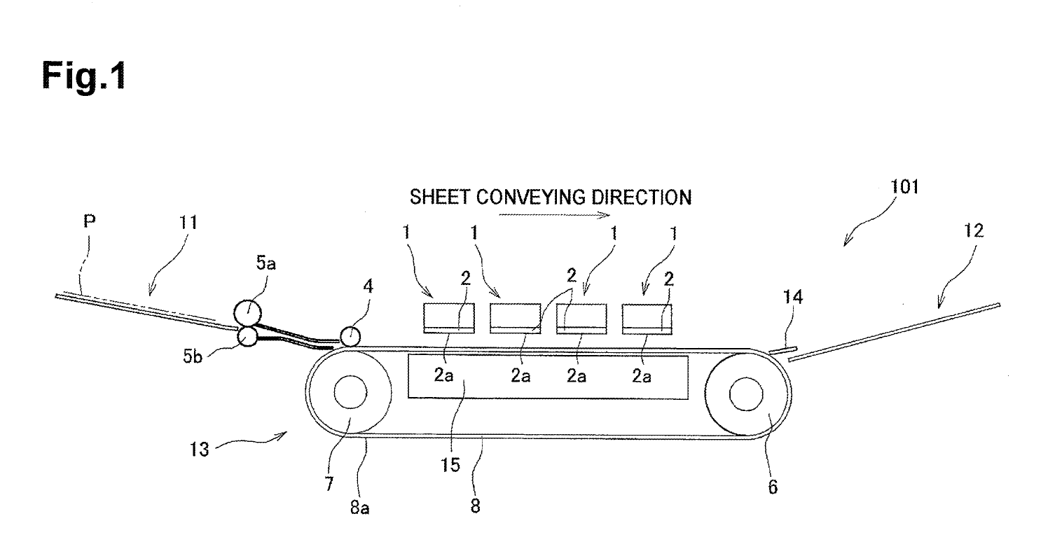

Referring to FIG. 1, an ink jet printer 101 may be a color ink jet printer including a plurality of, e.g., four, ink jet heads 1. The ink jet printer 101 may include a sheet feeding device 11 on the left side and a sheet discharge device 12 on the right side in FIG. 1.

A sheet conveying path extending from the sheet feeding device 11 to the sheet discharge device 12, along which a sheet P is conveyed, may be formed in the inkjet printer 101. A pair of feed rollers 5a and 5b, which nip and convey sheet P, may be positioned immediately on the downstream side of the sheet feeding device 11. The feed rollers 5a and 5b may feed the sheet P from the sheet feeding device 11 toward the right side in FIG. 1. A conveying mechanism 13 may be disposed in the middle of the sheet conveying path. The conveying mechanism 13 may include a plurality of, e.g., two, belt rollers 6 and 7, an endless conveying belt 8 that runs around the rollers 6 and 7, and a platen 15 disposed in a region surrounded by the conveying belt 8. The platen 15 may support the conveying belt 8 to prevent the conveying belt 8 from sagging downward, at a position opposing the inkjet heads 1. A nip roller 4 may be disposed at a position opposing the belt roller 7. The nip roller 4 may press the sheet P fed from the sheet feeding device 11 by the feed rollers 5a and 5b onto an outer circumference 8a of the conveying belt 8.

When a conveying motor (not shown) rotates the belt roller 6, the conveying belt 8 may run. Thus, the conveying belt 8 may convey the sheet P pressed onto the outer circumference 8a by the nip roller 4 to the sheet discharge device 12, while holding the sheet P by adhesion. The conveying belt 8 may include a weak-adhesive silicon resin layer on the surface.

A separating plate 14 may be disposed immediately on the downstream side of the conveying belt 8. The separating plate 14 may separate the sheet P adhered to the outer circumference 8a of the conveying belt 8 from the outer circumference 8a. The separating plate 14 may also guide the sheet P to the sheet discharge device 12 shown on the right side in FIG. 1.

The plurality of, e.g., four, ink jet heads 1 may correspond to ink of a plurality of, e.g., four, colors, namely, magenta, yellow, cyan, and black, and may be arranged in a conveying direction. The inkjet heads 1 each may have a head body 2 at the lower end. The head bodies 2 may have a rectangular-parallelepiped shape elongated in a direction perpendicular to the conveying direction. The bottom surfaces of the head bodies 2 may be ink ejection surfaces 2a opposing the outer circumference 8a of the conveying belt 8. When the sheet P conveyed by the conveying belt 8 sequentially passes immediately below the head bodies 2, ink droplets of respective colors may be ejected from the ink ejection surfaces 2a onto the upper surface, i.e., print surface, of the sheet P. Thus, a desired color image may be formed on the print surface of the sheet P.

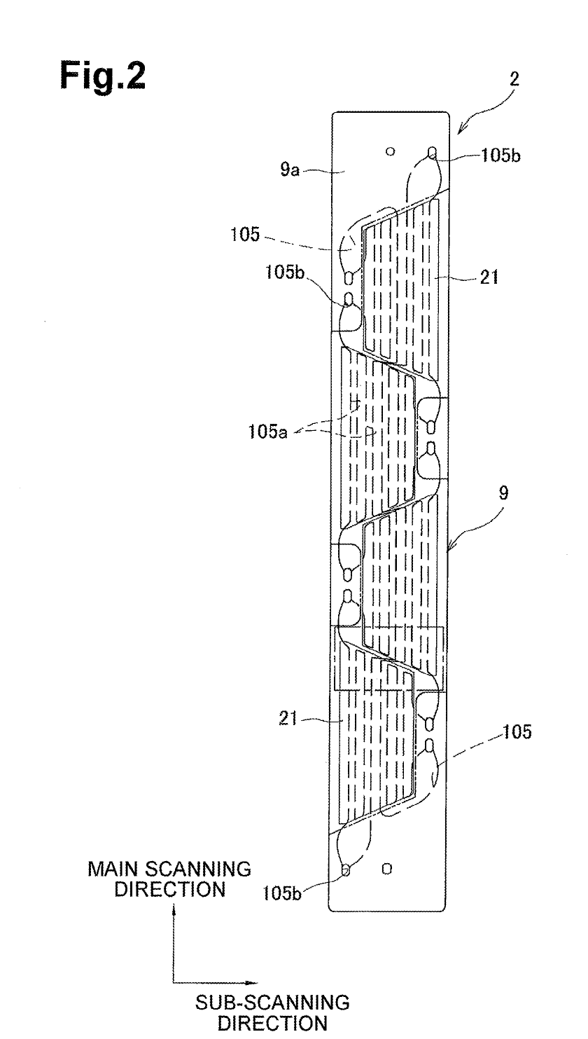

Referring to FIG. 2, each head body 2 may constitute the ink jet head 1, after being assembled with a reservoir unit (not shown) for storing ink from an ink tank (not shown) and supplying the ink to a channel unit 9 and a driver IC (not shown) for generating a driving signal for driving the actuator units 21. In the head body 2, a plurality of, e.g., four, actuator units 21 may be fixed to an upper surface 9a of the channel unit 9.

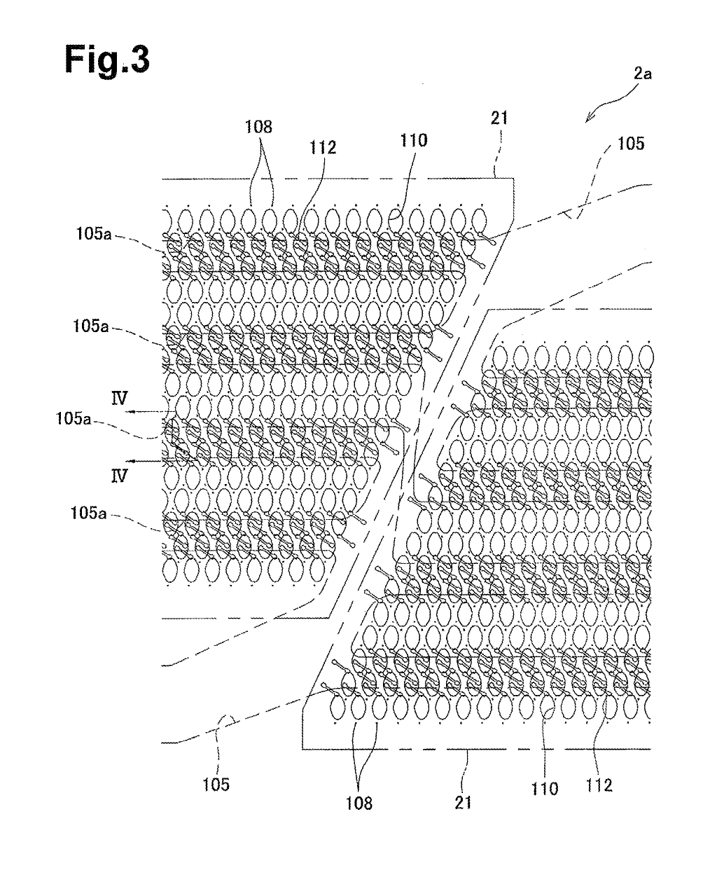

Referring to FIG. 3, the channel unit 9 may include ink channels including manifold channels 105, the pressure chambers 110, and the like. The actuator units 21 may include a plurality of actuators corresponding to the pressure chambers 110 and may selectively apply ejection energy to the ink in the pressure chambers 110 when driven by the driver IC. In FIG. 3, for convenience of explanation, pressure chambers 110, apertures 112, and nozzles 108 that are below actuator units 21 are illustrated by a solid line.

Each channel unit 9 may have a rectangular-parallelepiped-shape. The upper surface 9a of the channel unit 9 may have a plurality of, e.g., ten, ink supply ports 105b corresponding to ink discharge ports (not shown) of the reservoir unit. The channel unit 9 may include a plurality of, e.g., two, manifold channels 105, each communicating with a plurality of, e.g., five, ink supply ports 105b arranged in the longitudinal direction (i.e., main scanning direction) of the channel unit 9, at positions near edges of the channel unit 9 in the transverse direction (i.e., sub-scanning direction). Each manifold channel 105 may include a plurality of sub-manifold channels 105a that branch off therefrom and extend parallel to each other in the main scanning direction. The sub-manifold channels 105a may communicate with one another at both ends, and ink may flow therein from both ends in the direction in which the sub-manifold channels 105a extend. Thus, ink may flow in either direction in the sub-manifold channels 105a.

The ink ejection surface 2a including a plurality of the nozzles 108 arranged in a matrix may be formed at the lower surface of the channel unit 9. Similarly to the nozzles 108, a plurality of the pressure chambers 110 may be arranged in a matrix in a surface of the channel unit 9 to which the actuator units 21 are fixed.

A plurality of, e.g., sixteen, rows of the pressure chambers 110 that are arranged in the longitudinal direction of the channel unit 9 at equal distances apart from one another may be arranged parallel to one another in the transverse direction. The actuator units 21 may have a trapezoidal shape. Thus, the number of the pressure chambers 110 in each pressure chamber row may be gradually reduced from the long-side end to the short-side end of the actuator units 21 so as to conform to their shape. The nozzles 108 may be also arranged in this manner.

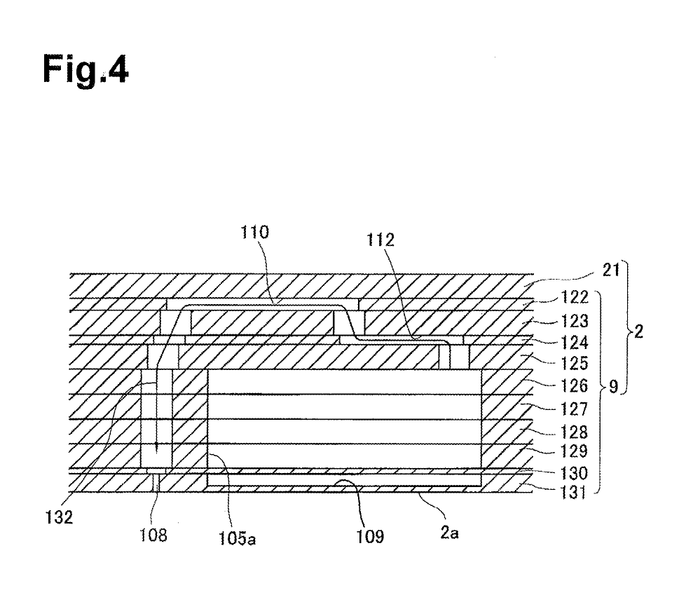

Referring to FIG. 4, the channel unit 9 may include a damper chamber 109 corresponding to each sub-manifold channel 105a. The damper chamber 109 may be a space formed between a damper plate 130 and a nozzle plate 131. The damper chamber 109 may be defined by the lower surface of the damper plate 130 and a recess formed in the upper surface of the nozzle plate 131. The nozzle plate 131 may also include the nozzles 108 through which the ink droplets are ejected. The damper plate 130 may function as the bottom of the sub-manifold channel 105a. Elastic deformation of the damper plate 130 in the damper chamber 109 may minimize pressure fluctuations in the sub-manifold channel 105a.

Each channel unit 9 may be composed of a plurality of, e.g., ten, plates 122 to 131 made of metal such as stainless steel. These plates 122 to 131, including a supply plate 125, manifold plates 126 to 129, the damper plate 130, and the nozzle plate 131, may be rectangular flat plates elongated in the main scanning direction.

By aligning and stacking these plates 122 to 131, through holes formed in the plates 122 to 131 may be connected. Thus, a plurality of, e.g., two, manifold channels 105, multiple individual ink channels 132 extending from supply ports 125a, functioning as the exits from the sub-manifold channels 105a of each manifold channel 105, through the pressure chambers 110 to the nozzles 108, and the damper chambers 109 may be formed in the channel unit 9.

Ink supplied from the reservoir unit through the ink supply ports 105b to the channel unit 9 may flow from the manifold channels 105 to the sub-manifold channels 105a. The ink in the sub-manifold channels 105a may flow into the individual ink channels 132, may pass through the apertures 112, functioning as throttles, and the pressure chambers 110, and may reach the nozzles 108.

Referring to FIG. 4, the manifold channels 105 may be formed by stacking, in sequence from top to bottom, the supply plate 125, the plurality of, e.g., four, manifold plates 126 to 129, and the damper plate 130. The supply plate 125 may function as the ceiling of the manifold channels 105 and may include the supply ports 152a each functioning as an end of the individual ink channel 132. The manifold plates 126 to 129 may define the side walls of the manifold channels 105. The damper plate 130 may function as the bottom of the manifold channels 105.

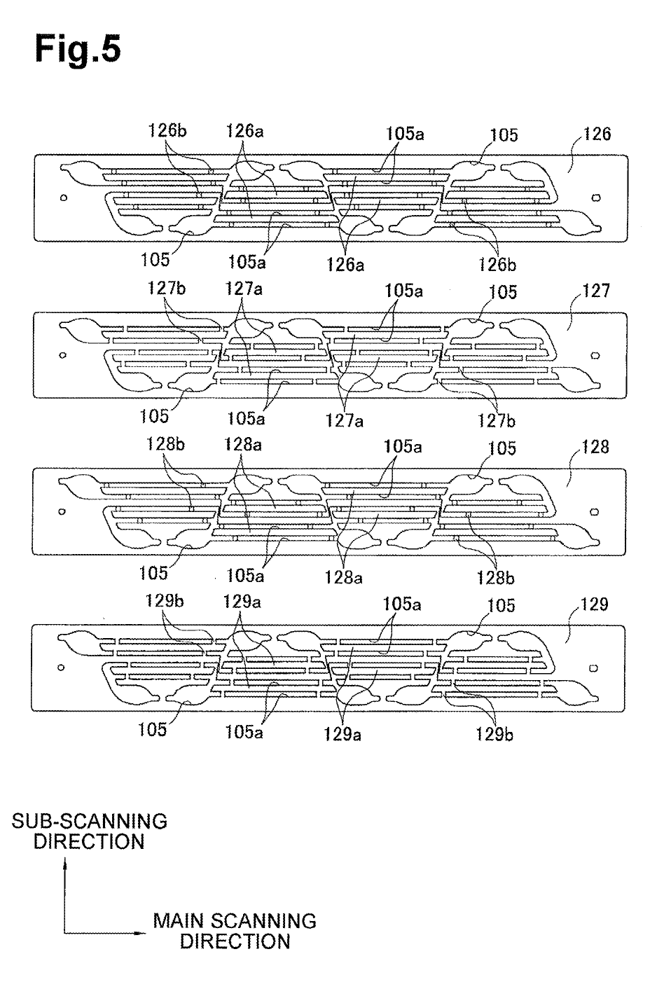

Referring to FIG. 5, the manifold plates 126, 127, 128, and 129 may include a plurality of island-shaped partial plates 126a, 127a, 128a, and 129a, respectively. The island-shaped partial plates 126a, 127a, 128a, and 129a may be surrounded by the manifold channels 105 (i.e., sub-manifold channels 105a) and may extend in one direction (i.e. a direction in which the sub-manifold channels 105a extend). Thus, the edges of the partial plates 126a, 127a, 128a, 129a may constitute the walls of the sub-manifold channels 105a. The manifold plates 126, 127, 128, and 129 may include support portions 126b, 127b, 128b, and 129b, respectively. The support portions 126b, 127b, 128b, and 129b may transverse the sub-manifold channels 105a and may support the partial plates 126a, 127a, 128a, and 129a. More specifically, the support portions 126b, 127b, 128b, and 129b may be disposed at positions that are close to both ends of each of the partial plates 126a, 127a, 128a, and 129a in the direction in which the sub-manifold channels 105a extend. Further, the support portions 126b, 127b, 128b, and 129b may be disposed on both sides of each of the partial plates 126a, 127a, 128a, and 129a with respect to the direction in which the partial plates 126a, 127a, 128a, and 129a extend.

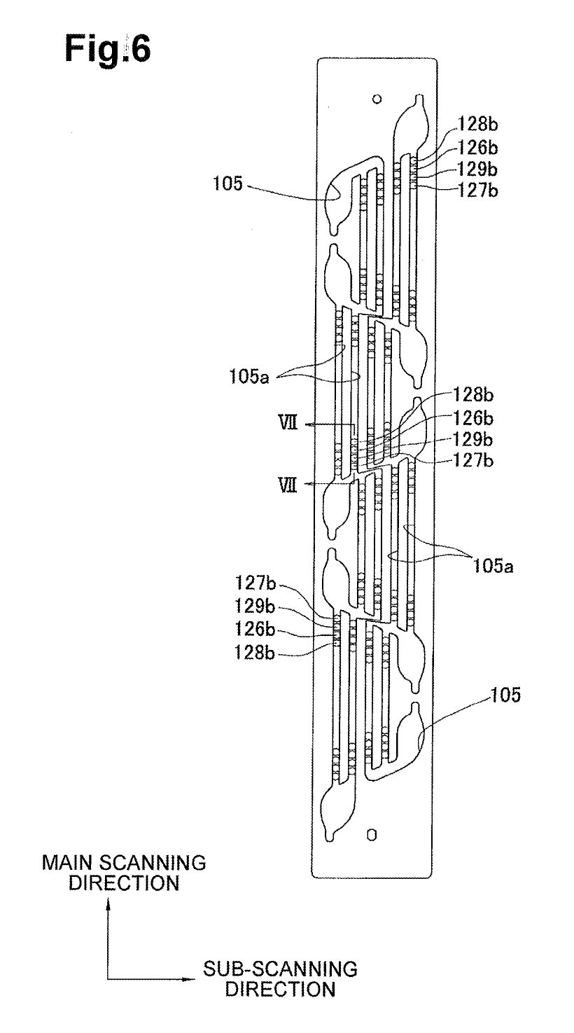

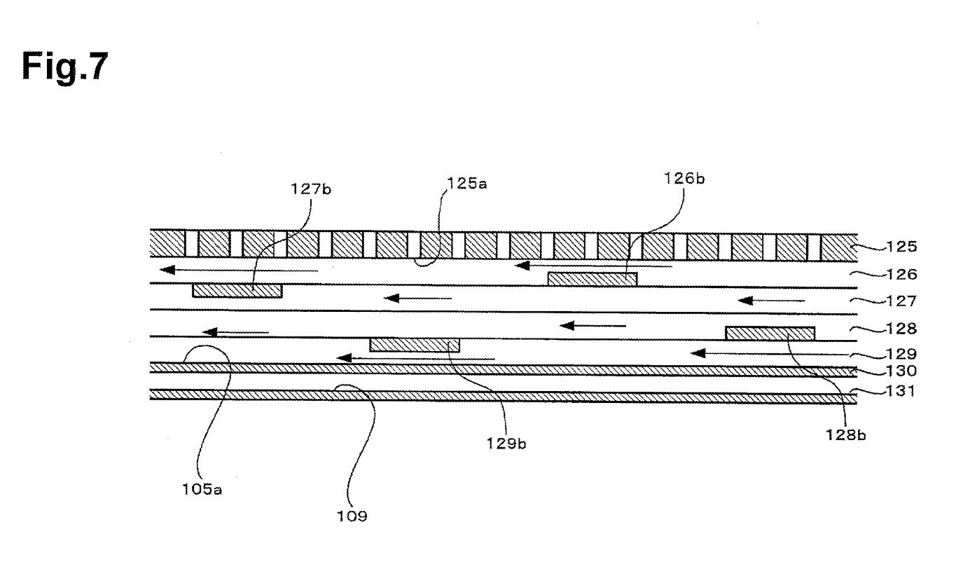

Referring to FIGS. 6 and 7, the upper surfaces (i.e., the surfaces adjacent to the supply plate 125) of the support portions 126b, the lower surfaces (i.e., the surfaces adjacent to the damper plate 130) of the support portions 127b, the upper surfaces of the support portions 128b, and the lower surfaces of the support portions 129b may be formed by half-etching. Therefore, the upper surfaces of the support portions 126b may be below those of the partial plates 126a. The lower surfaces of the support portions 127b may be above those of the partial plates 127a. The upper surfaces of the support portions 128b may be below those of the partial plates 128a. The lower surfaces of the support portions 129b may be above those of the partial plates 129a. The thickness of the support portions 126b, 127b, 128b, and 129b may be about half that of the partial plates 126a, 127a, 128a, and 129a, allowing ink and bubbles to smoothly flow in the sub-manifold channels 105a.

Because the upper surfaces of the support portions 126b are separated from the lower surface of the supply plate 125, the support portions 126b may not block ink flowing from the sub-manifold channels 105a through the supply ports 125a formed in the supply plate 125 to the individual ink channels 132. Thus, the ink and bubbles in the sub-manifold channels 105a may efficiently flow into the individual ink channels 132. Furthermore, because the lower surfaces of the support portions 129b are separated from the upper surface of the damper plate 130, the support portions 129b may not block the movement of the damper plate 130. Thus, the damper chambers 109 may efficiently minimize the pressure fluctuations in the sub-manifold channels 105a.

The support portions 127b and 128b may be disposed in the manifold plates 127 and 128, which are positioned in the middle of the sub-manifold channel 105a in the stacking direction. The surfaces of the support portions 127b opposing the middle of the sub-manifold channels 105a may be farther than that of the manifold plate 127 from the middle of the sub-manifold channels 105a. Similarly, the surfaces of the support portions 128b opposing the middle of the sub-manifold channels 105a may be farther than that of the manifold plate 128 from the middle of the sub-manifold channels 105a. This structure may increase the difference between the ink-flow rates on both sides of each of the support portions 127b and 128b in the stacking direction. Therefore, the bubbles that stick to the support portions 127b and 128b may easily flow with the ink flowing at a high rate and may not stay in the sub-manifold channels 105a.

A plurality of, e.g., four, support portions 126b, 127b, 128b, and 129b may be disposed at a predetermined distance from one another in the direction in which the sub-manifold channels 105a extend, near each end of the sub-manifold channels 105a in the extending direction thereof. Because the adjacent support portions 126b, 127b, 128b, and 129b are separated from one another in the ink-flow direction, bubbles may be prevented from staying between the adjacent support portions 126b, 127b, 128b, and 129b.

Each of the manifold plates 126, 127, 128, and 129, including the support portions 126b, 127b, 128b, and 129b, and the manifold plate 126, 127, 128, and 129, including the support portions 126b, 127b, 128b, and 129b, that are adjacent to the aforementioned support portions 126b, 127b, 128b, 129b in the direction in which the sub-manifold channels 105a extend may be stacked with one or two manifold plates interposed therebetween. In other words, one or two manifold plates may be disposed between the manifold plates including the support portions 126b, 127b, 128b, and 129b adjacent to each other in the extending direction of the channels. Accordingly, regardless of the distance between the support portions 126b, 127b, 128b, and 129b in the extending direction, bubbles may be less likely to stay between the adjacent support portions 126b, 127b, 128b, and 129b.

Referring to FIG. 7, in sequence from the right side, the support portions 128b, 126b, 129b, and 127b may be disposed in the direction in which the sub-manifold channels 105a extend. One manifold plate, namely, the manifold plate 127 may be disposed between the manifold plate 128 including the support portions 128b and the manifold plate 126 including the support portions 126b. Similarly, two manifold plates, namely, the manifold plates 127 and 128 may be disposed between the manifold plate 126 including the support portions 126b and the manifold plate 129 including the support portions 129b. Similarly, one manifold plate, namely, the manifold plate 128 may be disposed between the manifold plate 129 including the support portions 129b and the manifold plate 127 including the support portions 127b.

Thus, the distance, in the stacking direction, between the support portions adjacent to one another in the direction in which the sub-manifold channels 105a extend may be larger than the thickness of the manifold plates. This may prevent bubbles from staying between the adjacent support portions 126b, 127b, 128b, and 129b and may enable the bubbles flowing into the sub-manifold channels 105a to be efficiently discharged.

The plurality of, e.g., four, support portions 126b, 127b, 128b, and 129b may be disposed in the direction in which the sub-manifold channels 105a extend, alternately on the supply plate 125 side and the damper plate 130 side with respect to the middle of the sub-manifold channels 105a in the stacking direction. In other words, in the support portions 126b, 127b, 128b, and 129b, the relationship between the distances, in the stacking direction, between the ceiling of the sub-manifold channel 105a and the surface of the support portions 126b, 127b, 128b, and 129b opposing the ceiling and between the bottom of the sub-manifold channel 105a and the surface of the support portions 126b, 127b, 128b, and 129b opposing the bottom may be different from that in the adjacent support portions 126b, 127b, 128b, and 129b.

The closer to the ceiling or bottom of the sub-manifold channel 105a the support portions 126b, 127b, 128b, and 129b may be positioned, the higher the flow rate of ink passing therebetween. Thus, the relationship between the ink-flow rates on both sides of the support portion 126b, 127b, 128b, and 129b, in the stacking direction, may be opposite to that of the support portions 126b, 127b, 128b, and 129b adjacent to the aforementioned support portions 126b, 127b, 128b, and 129b in the direction in which the sub-manifold channels 105a extend. As a result, bubbles may change the rotation direction each time they pass the support portions 126b, 127b, 128b, and 129b. Accordingly, bubbles may be further prevented from staying between the adjacent support portions 126b, 127b, 128b, and 129b.

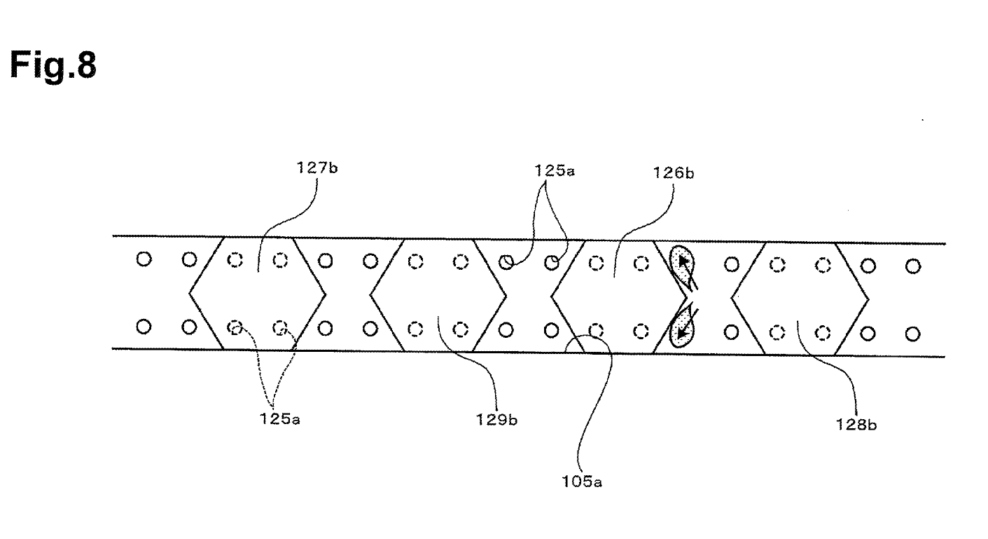

Referring to FIG. 8, the supply ports 125a may be formed in the ceiling of each sub-manifold channel 105a, near both edges in the width direction of the sub-manifold channel 105a (herein after referred to as “width direction”). The supply ports 125a may be arranged in a plurality of, e.g., two, rows in the direction in which the sub-manifold channel 105a extends (herein after referred to as “extending direction”).

Side edges of each of the support portions 126b, 127b, 128b, and 129b transverse the extending direction, as viewed in the stacking direction (i.e., the direction perpendicular to the surfaces of the manifold plates 126 to 129), may be inclined toward the center of the support portion 126b, 127b, 128b, and 129b in the extending direction, from the middle in the width direction to the side walls of the sub-manifold channel 105a. At least one of the side edges of each of the support portions 126b, 127b, 128b, and 129b may be inclined toward the downstream side of the ink-flow direction. Thus, the side edges of each of the support portions 126b, 127b, 128b, and 129b may project in the extending direction, in the middle in the width direction. In this embodiment, as viewed in the stacking direction, each support portions 126b, 127b, 128b, and 129b may have a line-symmetrical shape with respect to an imaginary line extending in the width direction.

As has been described, the supply ports 125a may be arranged near both edges in the width direction, and the apexes of the side edges of the support portions 126b, 127b, 128b, and 129b may be arranged in the middle in the width direction. In other words, the apexes of the side edges of the support portions 126b, 127b, 128b, and 129b may be arranged so as to oppose a region where the supply ports 125a are not arranged. The side edges of the support portions 126b, 127b, 128b, and 129b may be inclined to the ink-flow direction, as viewed in the stacking direction.

For example, when ink flows in the sub-manifold channel 105a from the right side to the left side in FIG. 8, the bubbles flowing into the sub-manifold channel 105a may collide with the apexes of the side edges of the support portions 126b, 127b, 128b, and 129b and may break into small bubbles (in FIG. 8, the bubble collides with the support portion 126b). Then, the small bubbles may move along the inclined side edges of the support portions 126b, 127b, 128b, and 129b, from the middle in the width direction to the side walls of the sub-manifold channel 105a (see the arrows). Thus, the small bubbles may move in the ink-flow direction so as to be guided to the supply ports 125a, which also function as ink discharge ports.

According to this embodiment, because the side edges of the support portions 126b, 127b, 128b, and 129b are inclined to the ink-flow direction, the bubbles flowing into the sub-manifold channel 105a may easily move in the flow direction along the inclined side edges of the support portions 126b, 127b, 128b, and 129b. Because this prevents the bubbles flowing into the sub-manifold channels 105a from sticking to and staying at the support portions 126b, 127b, 128b, and 129b, the bubbles may be efficiently discharged.

Furthermore, because the side edges of the support portions 126b, 127b, 128b, and 129b project outward in the extending direction in the middle in the width direction, the bubbles flowing into the sub-manifold channels 105a may collide with the apexes of the side edges of the support portions 126b, 127b, 128b, and 129b and may break into small bubbles. Thus, the bubbles flowing into the sub-manifold channels 105a may be further efficiently discharged.

The supply ports 125a may be arranged near both edges in the width direction, and the side edges of each of the support portions 126b, 127b, 128b, and 129b transverse the extending direction, as viewed in the stacking direction, may be inclined from the middle in the width direction toward the downstream side of the ink-flow direction. Therefore, the bubbles broken into small bubbles by the apexes of the side edges of the support portions 126b, 127b, 128b, and 129b may flow in the ink-flow direction so as to be guided to the supply ports 125a. Thus, the bubbles flowing into the sub-manifold channel 105a may be further efficiently discharged.

Furthermore, because the support portions 126b, 127b, 128b, and 129b are each line-symmetrical with respect to an imaginary line extending in the width direction as viewed in the stacking direction, the bubbles flowing into the sub-manifold channels 105a from both ends may be efficiently discharged.

### Modification Examples

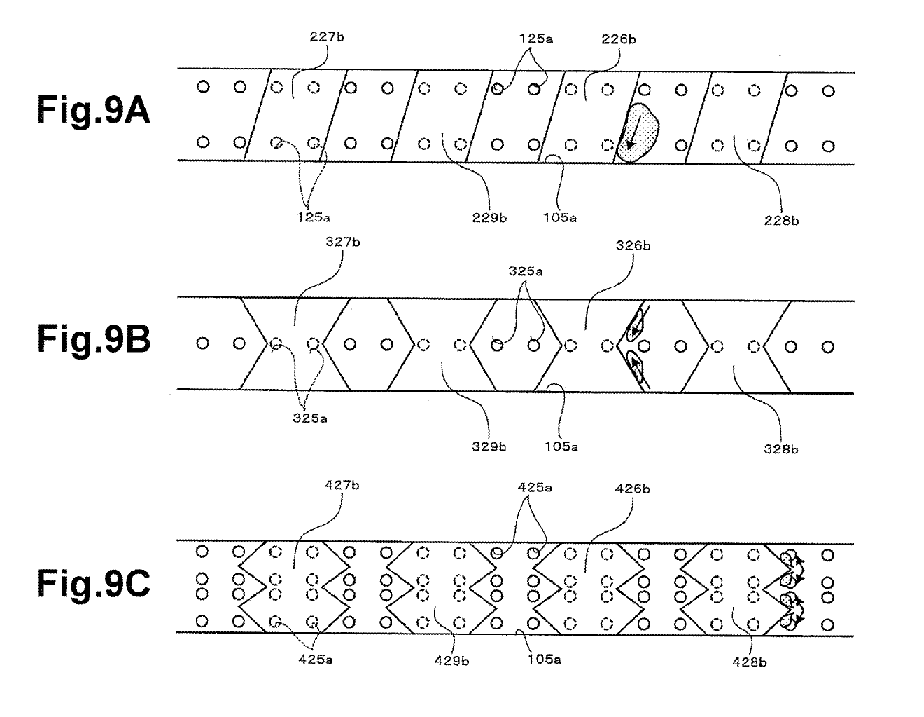

Referring to FIGS. 9A to 9C, modification examples of the present invention will be described. In the above-described embodiment, the side edges of each of the support portions 126b, 127b, 128b, and 129b may project outward in the extending direction, in the middle in the width direction, as viewed in the stacking direction. However, the shape of the support portions 126b, 127b, 128b, and 129b is not limited to such a shape. For example, in the modification example shown in FIG. 9A, support portions 226b, 227b, 228b, and 229b each may include connection portions at both ends, and the support portions 226b, 227b, 228b, and 229b each may be connected to the side walls of the sub-manifold channel 105a at the connection portions. The connection portions positioned at one end may be positioned on the upper stream side in the flow direction than the connection portions positioned at the other end. More specifically, the side edges of the support portions 226b, 227b, 228b, and 229b transverse the extending direction (i.e., ink-flow direction), as viewed in the stacking direction, may be inclined to the ink-flow direction (i.e., extending direction) and may extend parallel to each other. That is, the support portions 226b, 227b, 228b, and 229b may have a parallelogram shape. Accordingly, as viewed in the stacking direction, each support portions 226b, 227b, 228b, and 229b may have a point-symmetrical shape. Because the support portions 226b, 227b, 228b, and 229b may have a simple shape, the manifold plates may be easily fabricated.

When ink flows in the sub-manifold channel 105a from the right side to the left side in FIG. 9A, the bubbles flowing into the sub-manifold channel 105a may move along the side edges of the support portions 226b, 227b, 228b, and 229b with which they collided to the side wall of the sub-manifold channel 105a on the lower side in FIG. 9A (see the arrow). Thus, the bubbles flowing into the sub-manifold channel 105a may move in the ink-flow direction so as to be guided to the supply ports 125a (the exits from the sub-manifold channel 105a) arranged along the side wall of the sub-manifold channel 105a on the lower side in FIG. 9A.

In the modification example shown in FIG. 9B, a plurality of supply ports 325a may be arranged in the middle in the width direction. Side edges of each of support portions 326b, 327b, 328b, and 329b transverse the extending direction, as viewed in the stacking direction, may be inclined away from the center in the extending direction, from the middle in the width direction to the side walls of the sub-manifold channel 105a. At least one of the side edges of each of the support portions 326b, 327b, 328b, and 329b may be inclined toward the upstream side of the ink-flow direction. Thus, the side edges of the support portions 326b, 327b, 328b, and 329b may be recessed in the extending direction in the middle in the width direction. In this modification example, each support portions 326b, 327b, 328b, and 329b may have a line-symmetrical shape with respect to an imaginary line extending in the width direction, as viewed in the stacking direction. The bottoms of the recessed side edges of the support portions 326b, 327b, 328b, and 329b may be arranged so as to oppose a region where supply ports 325a are provided.

For example, when ink flows in the sub-manifold channel 105a from the right side to the left side in FIG. 9B, the bubbles flowing into the sub-manifold channel 105a may collide with the side edges of the support portions 326b, 327b, 328b, and 329b and may move along the inclined side edges of the support portions 326b, 327b, 328b and 329b toward the middle in the width direction (see the arrows). Thus, the bubbles flowing into the sub-manifold channels 105a may move in the ink-flow direction so as to be guided to the supply ports 325a arranged in the middle in the width direction of the sub-manifold channels 105a.

In the modification example shown in FIG. 9C, a plurality of supply ports 425a may be arranged near both edges in the width direction. In addition, the supply ports 425a may be arranged in a plurality of, e.g., two, rows in the extending direction, in the middle in the width direction. Side edges of each of support portions 426b, 427b, 428b and 429b transverse the extending direction, as viewed in the stacking direction, may be each inclined toward the upstream side of the ink-flow direction from the middle in the width direction to the midpoints between the middle and the side walls of the sub-manifold channel 105a. The side edges of each of support portions 426b, 427b, 428b and 429b may be also inclined toward the downstream side of the flow direction, from the midpoints to the side walls of the sub-manifold channel 105a. Thus, the side edges of the support portions 426b, 427b, 428b and 429b each may have a plurality of, e.g., two, projections pointing outward in the extending direction, at the midpoints in the width direction. Each support portions 426b, 427b, 428b and 429b may have a line-symmetrical shape with respect to an imaginary line extending in the width direction, as viewed in the stacking direction. The recess and projections may be formed at least the side wall on the upstream side of the flow direction.

For example, when ink flows in the sub-manifold channel 105a from the right side to the left side in FIG. 9C, the bubbles flowing into the sub-manifold channel 105a may collide with the apexes of the projections of the side edges of the support portions 426b, 427b, 428b and 429b and may break into small bubbles. The small bubbles may move along the inclined side edges of the support portions 426b, 427b, 428b and 429b from the midpoints in the width direction to the middle and to the side walls of the sub-manifold channels 105a (see the arrows). As a result, the small bubbles moving toward the side walls of the sub-manifold channel 105a may move in the ink-flow direction toward the supply ports 425a arranged near both edges in the width direction of the sub-manifold channel 105a. The bubbles moving from the midpoints toward the middle in the width direction may be guided to the supply ports 425a in the middle portion. Thus, the bubbles may be rapidly discharged from the supply ports 425a together with the ink to be discharged.

Although the embodiments have been described above, the present invention is not to be limited thereto. For example, although the support portions 126b, 127b, 128b, 129b, 226b, 227b, 228b, 229b, 326b, 327b, 328b, 329b, 426b, 427b, 428b, and 429b may be line-symmetrical in the above-described embodiments, the support portions do not have to be line-symmetrical or point-symmetrical. In particular, when ink flows in the sub-manifold channels in one direction, only at least part of the side edges positioned on the upstream side of the flow direction may be inclined to the flow direction.

In the above-described embodiments, each of the manifold plates 126, 127, 128, and 129 including the support portions 126b, 127b, 128b, and 129b and each of the manifold plates 126, 127, 128, 129 including the support portions 126b, 127b, 128b, and 129b adjacent to the aforementioned support portions 126b, 127b, 128b, and 129b in the extending direction of the sub-manifold channels 105a may be stacked with one or two manifold plates 126, 127, 128, 129 interposed therebetween. However, the stacking order of the manifold plates 126 to 129, i.e., the positional relationship of the support portions 126b, 127b, 128b, and 129b in the stacking direction, may be arbitrary. Furthermore, the positional relationship of the support portions 126b, 127b, 128b, and 129b in the extending direction may also be arbitrary.

Although embodiments have been described in detail herein, the scope of this patent is not limited thereto. It will be appreciated by those of ordinary skill in the relevant art that various modifications may be made without departing from the scope of the invention. Accordingly, the embodiments disclosed herein are exemplary, and are not limiting. It is to be understood that the scope of the invention is to be determined by the claims which follow.

What is claimed is:

1. A liquid-droplet ejection head comprising stacked plates that form therein a common liquid channel and a plurality of individual ink channels extending from exits from the common liquid channel to nozzles via pressure chambers, wherein at least one of the stacked plates comprise:
an island-shaped partial plate surrounded by the common liquid channel and configured to form at least a part of side walls of the common liquid channel, and
a support portion that transverse the common liquid channel and configured to support the partial plate; and
wherein at least a part of a side edge of the support portion on an upstream side of a flow direction of liquid in the common liquid channel is inclined to the flow direction, as viewed in a direction perpendicular to the stacked plates.

2. The liquid-droplet ejection head according to claim 1,
wherein the exits from the common liquid channel are arranged in a direction in which the common liquid channel extends.

3. The liquid-droplet ejection head according to claim 2,
wherein the side edge of the support portion on the upstream side comprises a recess whose bottom portion opposes a region where the exits from the common liquid channel are arranged, as viewed in the direction perpendicular to the stacked plates.

4. The liquid-droplet ejection head according to claim 3,
wherein the exits from the common liquid channel are arranged in the middle in a width direction of the common liquid channel.

5. The liquid-droplet ejection head according to claim 4,
wherein the side edge of the support portion on the upstream side is inclined toward the upstream side of the flow direction, from the middle in the width direction of the common liquid channel to the side walls of the common liquid channel, as viewed in the direction perpendicular to the stacked plates.

6. The liquid-droplet ejection head according to claim 1,
wherein at least a part of the side edge of the support portion on the upstream side is projected, as viewed in the direction perpendicular to the stacked plates.

7. The liquid-droplet ejection head according to claim 6,
wherein the exits from the common liquid channel are arranged in a direction in which the common liquid channel extends.

8. The liquid-droplet ejection head according to claim 7,
wherein an apex of the projected side edge of the support portion on the upstream side opposes a region where the exits are not arranged, as viewed in the direction perpendicular to the stacked plates.

9. The liquid-droplet ejection head according to claim 8,
wherein the exits from the common liquid channel are arranged near both edges in a width direction of the common liquid channel.

10. The liquid-droplet ejection head according to claim 9,
wherein the side edge of the support portion on the upstream side is inclined toward a downstream side of the flow direction, from the middle in the width direction of the common liquid channel to the side walls of the common liquid channel, as viewed in the direction perpendicular to the stacked plates.

11. The liquid-droplet ejection head according to claim 9,
wherein the side edge of the support portion on the upstream side is inclined toward the upstream side of the flow direction, from the middle in a width direction of the common liquid channel to midpoints between the middle and the side walls of the common liquid channel, and is inclined toward the downstream side of the flow direction, from the midpoints to the side walls of the common liquid channel, as viewed in the direction perpendicular to the stacked plates.

12. The liquid-droplet ejection head according to claim 1,
wherein the support portion has a line-symmetrical shape as viewed in the direction perpendicular to the stacked plates.

13. The liquid-droplet ejection head according to claims 1,
wherein the support portion has a point-symmetrical shape as viewed in the direction perpendicular to the stacked plates.

14. The liquid-droplet ejection head according to claim 1,
wherein the support portion has a parallelogram shape as viewed in the direction perpendicular to the stacked plates.

15. The liquid-droplet ejection head according to claim 1,
wherein the side edges of the support portions on an upstream side and downstream side of a flow direction of liquid in the common liquid channel are inclined to the flow direction, as viewed in a direction perpendicular to the stacked plates.

16. The liquid-droplet ejection head according to claim 1,
wherein the support portions are disposed at positions that are close to both ends of each of the partial plates in the direction in which the sub-manifold channels extend.

17. The liquid-droplet ejection head according to claim 1,
wherein the support portions are disposed on both sides of each of the partial plates with respect to the direction in which the partial plates extend.

18. The liquid-droplet ejection head according to claim 1,
wherein the stacked plates further comprises:
a first plate that comprises a first partial plate and a first support portion that supports the first partial plate,
a second plate that comprises a second partial plate and a second support portion that is adjacent to the first support portion in a direction in which the common liquid channel extends, the second support portion supporting the second partial plate, and
at least one plate that is interposed between the first plate and the second plate.

19. An ink jet printer comprising:
a liquid-droplet ejection head comprising stacked plates that form therein a common liquid channel and a plurality of individual ink channels extending from exits from the common liquid channel to nozzles via pressure chambers,
a sheet feeding device configured to feed a recording medium,
a sheet discharge device configured to discharge the recording medium, and
a sheet conveying path extending from the sheet feeding device to the sheet discharge device along which the recording medium is conveyed; and
wherein at least one of the stacked plates comprise:
an island-shaped partial plate surrounded by the common liquid channel and configured to form at least a part of side walls of the common liquid channel, and
a support portion that transverse the common liquid channel and configured to support the partial plate; and
wherein at least a part of a side edge of the support portion on an upstream side of a flow direction of liquid in the common liquid channel is inclined to the flow direction, as viewed in a direction perpendicular to the stacked plates.
